(19) United States
(12) Patent Application Publication
(10) Pub. No.: US 2026/0206725 A1
(43) Pub. Date: Jul. 23, 2026

(54) WASHABLE LEASH WITH REMOVABLE HARDWARE

(71) Applicant: Jocelyn Erica Potthoff, Gorham, ME (US)

(72) Inventor: Jocelyn Erica Potthoff, Gorham, ME (US)

(21) Appl. No.: 19/442,565

(22) Filed: Jan. 7, 2026

Related U.S. Application Data
(60) Provisional application No. 63/748,236, filed on Jan. 22, 2025.

(51) Int. Cl. A01K 27/00

(52) U.S. Cl. CPC A01K 27/005; A01K 27/003

(57) ABSTRACT

A washable leash with removable hardware is disclosed. The leash comprises a flexible strap with a handle portion at one end and one or more carabiner loops at the opposite end. A carabiner is removably attached to the carabiner loop, allowing the carabiner to be completely detached from the leash. This design enables the entire fabric portion of the leash to be machine washed, including using sterilization wash settings, to eliminate pathogens, parasites, allergens, and infectious diseases. The user simply unhooks the carabiner and places the leash in the washing machine, avoiding the time-consuming and often ineffective process of hand washing. The leash may also include accessory loops for attaching additional hardware such as secondary carabiners or D-rings, and may incorporate reflective materials for enhanced visibility during low-light conditions.

### CROSS-REFERENCE TO RELATED APPLICATION

This application claims the benefit of U.S. Provisional Patent Application No. 63/748,236, filed Jan. 22, 2025, which is incorporated herein by reference in its entirety.

### FILED OF THE INVENTION

The present invention relates generally to pet accessories, and more particularly to a washable leash with removable hardware that enables thorough machine washing and sanitization.

### BACKGROUND OF THE INVENTION

Pet leashes are essential accessories for dog owners and are used daily for walks, training, and restraint. However, dirty leashes are inevitable during regular use. Keeping them clean is tedious work that most pet owners struggle to maintain effectively.

Leashes commonly harbor more contaminants than most users anticipate, including urine, slobber, dirt, oils, grime, and sweat. More concerning, they can also transmit skin allergens and infectious diseases such as ringworm, mites, E. coli, canine cough, yeast, and even toxic substances, to name a few. These contaminants pose risks not only to the pet but also to human handlers, particularly children and immunocompromised individuals.

Traditional leashes present significant cleaning challenges. Nearly all leashes currently on the market are unfit for a washing machine without additional wrapping, hand-cleaning, and special care. The metal hardware is not removable, and cannot withstand machine washing and may damage both the leash material and the washing machine itself. This forces users to either hand-wash their leashes (a time-consuming and often incomplete cleaning method) or avoid washing them altogether.

Traditional cleaning methods often result in a lingering odor that is displeasing and disappointingly dirty smelling, even after extensive scrubbing. Handwashing requires soaking the leash, manually scrubbing to remove embedded contaminants, and thorough rinsing—a process that is labor-intensive and frequently fails to eliminate harmful pathogens and allergens. Moreover, the hardware attachment points remain difficult to clean effectively, creating persistent reservoirs for bacterial growth.

Therefore, there exists a need for a leash design that allows for complete machine washing, including the use of high-temperature sanitization cycles, while maintaining the structural integrity and functionality of the leash. Such a solution would enable pet owners to regularly and thoroughly clean their leashes, thereby minimizing or eradicating the transmission of harmful pathogens, parasites, allergens, and infectious diseases.

Future designs are not limited to electrical grade PVC as used for the initial prototype. Heat rated PVC coatings are one possible iteration. Materials will improve with advancements in technologies as well as the leash construction formula.

### SUMMARY OF THE INVENTION

The present invention addresses the aforementioned needs by providing a washable leash with removable hardware. The invention enables complete machine washing of the leash material while protecting the hardware components.

In accordance with one aspect of the present invention, a washable pet leash comprises a flexible strap having a first end and a second end; a handle portion disposed at the first end of the flexible strap; at least one carabiner loop disposed at the second end of the flexible strap, wherein the carabiner loop is configured to removably receive a carabiner to allow the flexible strap to be machine washed.

In accordance with another aspect of the invention, the material may improve with time. Reflective and/or luminescent properties may also be used. The current PVC coating formula contains a glow powder that is light activated. Simply charge the leash under any LED for 10 minutes to enjoy 40+ minutes of residual after-glow.

In accordance with yet another aspect of the invention, the leash may include at least one accessory loop positioned adjacent to either the handle portion or the carabiner loop, wherein the accessory loop is configured to receive additional hardware such as a secondary carabiner, a D-ring or the like.

In accordance with a further aspect of the invention, the carabiner loops may be configured to allow the leash to be shortened by threading the flexible strap through one or more carabiner loops, thereby converting the leash into a control-lead or safety restraint configuration.

The present invention provides a simple way to bypass the mess and avoid the time it takes to soak a leash and the labor of scrubbing and rinsing it clean. A user simply unhooks the carabiner and tosses the leash in the wash. Many washing machines have a “sterilization” washing setting, which is by far the best option for eliminating pathogens. However, a “normal” setting will also provide significant cleaning benefits.

By enabling regular machine washing as intended, the transmission of harmful pathogens, parasites, allergens, and infectious diseases can be minimized if not eradicated, promoting better health for both pets and their human companions.

These and other features, aspects and advantages of the present invention will become better understood with reference to the following drawings, description and claims.

### BRIEF DESCRIPTION OF THE DRAWINGS

The accompanying drawings, which are incorporated in and constitute a part of this specification, illustrate embodiments of the invention and, together with the description, serve to explain the principles of the invention.

FIG. 1 is a perspective view of a leash constructed in accordance with a preferred embodiment of the present invention, showing the handle portion and hardware portion;

FIG. 1A is an exploded view of the handle portion of the leash of FIG. 1, showing the handle, accessory loop, and safety stitching;

FIG. 1B is an exploded view of the hardware portion of the leash of FIG. 1, showing the carabiner installed in a carabiner loop, an accessory loop, and safety stitching;

FIG. 2 is a detailed perspective view of the hardware portion of the leash, showing the carabiner with its latch in an open position within the carabiner loop, along with an accessory loop;

FIG. 3A is a perspective view of an exemplary leash embodiment having a handle and a carabiner installed in a carabiner loop, along with an accessory in the top accessory loop;

FIG. 3B is a perspective view of an exemplary leash embodiment having a handle, accessory loop with safety stitching, a carabiner installed in a carabiner loop, and a second carabiner installed in an accessory loop, together with a reflective ribbon integrated into the handle; and

FIG. 3C is a perspective view of an exemplary leash embodiment having a handle, accessory loop with safety stitching, a carabiner installed in a carabiner loop, and a D-ring installed in an accessory loop, together with a reflective ribbon integrated into the handle.

### DETAILED DESCRIPTION OF THE INVENTION

Reference will now be made in detail to exemplary embodiments of the invention, examples of which are illustrated in the accompanying drawings. Wherever possible, the same reference numbers will be used throughout the drawings to refer to the same or like parts.

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a washable leash with removable hardware that addresses the long-standing problem of maintaining clean, sanitary pet leashes. As previously noted, dirty leashes are inevitable and keeping them clean through traditional methods is tedious work. Leashes commonly harbor urine, slobber, dirt, oils, grime, and sweat, and they also transmit skin allergens and infectious diseases including ringworm, mites, E. coli, canine cough, yeast, and even toxic substances.

### Structure and Components

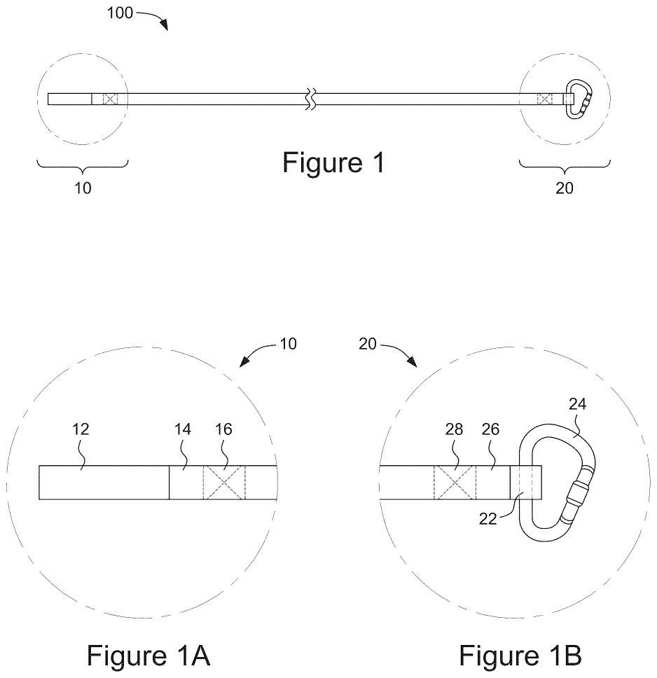

Referring now to FIG. 1, a leash 100 constructed in accordance with a preferred embodiment of the present invention is shown. Leash 100 comprises a handle portion 10 located at a first end and a hardware portion 20 located at a second end, connected by a flexible elongated strap.

As shown in FIG. 1A, which provides an exploded view of handle portion 10, the handle comprises a handle 12, which may be formed as a loop or padded grip area for comfortable holding by a user. The handle portion 10 may further include an accessory loop 16 secured with safety stitching 14. The safety stitching 14 reinforces the connection points to ensure structural integrity under the stress and strain of regular use, particularly when restraining a pulling dog. As noted, additional accessory loops exist at the top and bottom of the leash. The current orientation is not limited to these placements. Whilst maintaining the detachable hardware properties unique to the machine-friendly design, additional loops and a traffic handle may be added in the future.

FIG. 1B provides an exploded view of hardware portion 20 of leash 100. The hardware portion includes a carabiner loop 22 configured to removably receive a carabiner 24. The carabiner 24 is a spring-loaded clip device that allows for quick attachment to and detachment from a pet's collar or harness. Importantly, carabiner 24 is entirely removable from carabiner loop 22, enabling the fabric portions of the leash to be machine washed without the hardware. Hardware portion 20 may also include an accessory loop 26 secured with safety stitching 28. The accessory loop 26 provides an additional attachment point for secondary hardware or accessories.

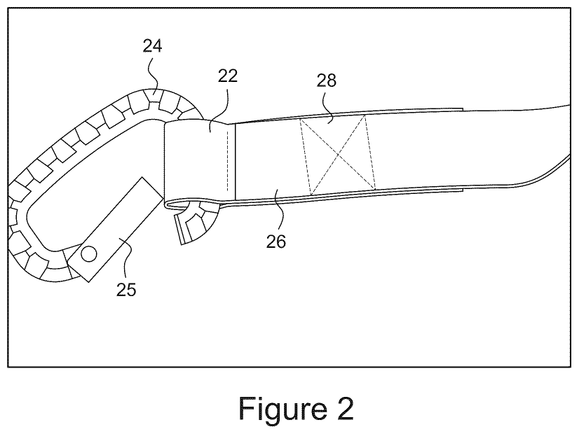

FIG. 2 provides a detailed perspective view of hardware portion 20, particularly illustrating carabiner 24 with its latch 25 in an open position within carabiner loop 22. This view demonstrates how the carabiner 24 can be easily removed from carabiner loop 22 by opening latch 25 and disengaging the carabiner. The figure also clearly shows accessory loop 26 and safety stitching 28 that reinforces the connection point.

### Exemplary Embodiments

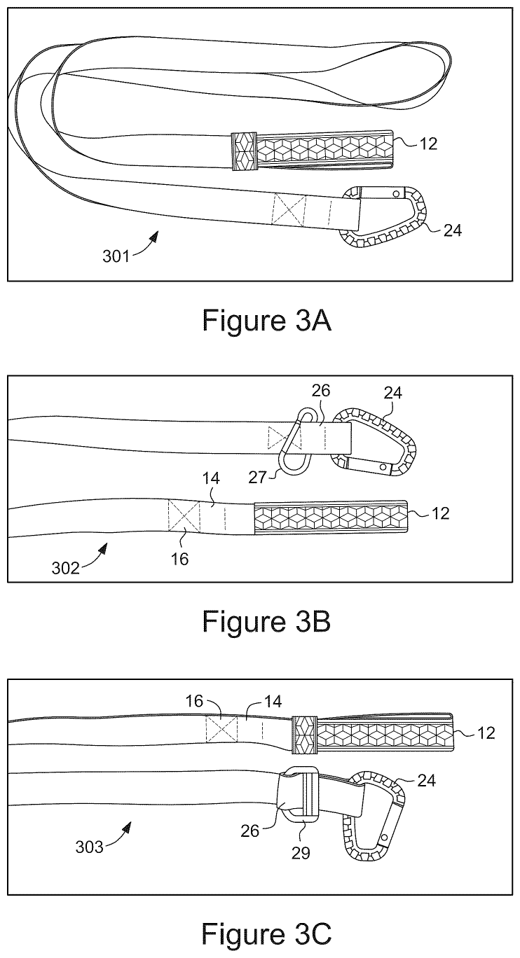

FIGS. 3A, 3B, and 3C illustrate three exemplary embodiments of the present invention, demonstrating the versatility of the design and various configurations that may be employed.

FIG. 3A shows an exemplary leash 301 representing a basic embodiment. Leash 301 includes handle 12 at one end and carabiner 24 installed in carabiner loop 22 at the opposite end. In this embodiment, glow powder (not numbered) has been incorporated into the PVC coating for enhanced visibility during low-light conditions, as is used in the prototype. This streamlined configuration provides the essential functionality of a machine-washable leash with minimal components.

FIG. 3B illustrates an exemplary leash 302 representing a more feature-rich embodiment. Leash 302 includes handle 12 with an adjacent accessory loop 14 secured by safety stitching 16 near the handle end. At the hardware end, leash 302 includes carabiner 24 installed in carabiner loop 22 for attachment to the pet's collar and additionally includes a second carabiner 27 installed in accessory loop 26. In this embodiment, glow powder (not numbered) has been added into the heat-rated PVC coating for enhanced visibility during low-light conditions, as is used in the prototype. This configuration provides multiple attachment points, which may be useful for various purposes such as attaching waste bag dispensers, training aids, or creating adjustable-length configurations.

FIG. 3C depicts an exemplary leash 303 showing another variation. Leash 303 includes handle 12 with accessory loop 14 and safety stitching 16, as well as carabiner 24 installed in carabiner loop 22. However, in this embodiment, a D-ring 29 is installed in accessory loop 26 instead of a second carabiner. The D-ring 29 provides an alternative attachment point that may be preferred for certain accessories or applications where a fixed ring is more suitable than a carabiner.

### Materials and Construction

In a preferred embodiment, the flexible strap of leash 100 is constructed from a durable material, such as electrical grade PVC or the like, and is approximately 5 feet in length, though other lengths such as 4 feet, 6 feet, or custom lengths may be employed. The material is selected for its strength, durability, and ability to withstand repeated machine washing without significant degradation.

The handle 12 may incorporate a reflective ribbon sewn into or onto the strap material to enhance visibility during low-light conditions, as shown by way of example in FIG. 3. This safety feature allows vehicles and pedestrians to see the dog and handler more easily during early morning or evening walks.

The carabiner loops 22 and accessory loops 14, 26 are formed by folding the strap material back on itself and securing it with safety stitching 14, 28. This construction method creates robust loops capable of withstanding the forces exerted during use while remaining machine washable. In some embodiments, the loops may be reinforced with additional layers of material or specialized stitching patterns to enhance durability.

### Functional Advantages

The key innovation of the present invention is the detachable hardware design. By enabling the carabiner 24 to be removed entirely from carabiner loop 22, the entire fabric portion of the leash can be machine washed without risk of damage to the washing machine or the hardware components. Some of the benefits provided by the design of the present invention include:

Enhanced Hygiene: Machine washing, particularly using sterilization or hot water settings, effectively eliminates bacteria, viruses, parasites, and allergens that accumulate on the leash during use. This is vastly superior to hand washing, which rarely achieves adequate sanitization.

Time and Labor Savings: Users can simply unhook the carabiner and toss the leash into the washing machine with regular laundry, eliminating the need for soaking, scrubbing, and rinsing by hand.

Odor Elimination: Machine washing with detergent and high temperatures eliminates the lingering odors that often persist even after hand washing.

Disease Prevention: Regular sanitization minimizes the transmission of infectious diseases between pets and from pets to humans, which is particularly important in multi-pet households or when dogs interact with other animals during walks.

### Versatile Configurations

The multiple loop design provides additional functional versatility. The carabiner loops 22 can be used not only for attaching hardware but also for shortening the leash by threading the strap through the loops. This allows the leash to be converted into a control-lead configuration for situations requiring closer control of the pet, or as a safety restraint for temporary tethering.

The accessory loops 14, 26 provide attachment points for various accessories such as waste bag dispensers, training clickers, treat pouches, or identification tags. As shown in FIGS. 3B and 3C, these loops can accommodate either additional hardware, such as carabiners 27 or D-rings 29, depending on the user's preference and specific application needs.

### Alternative Handle Designs

While the illustrated embodiments show a standard loop-style handle 12, alternative handle configurations may be employed without departing from the scope of the invention. For example, a padded handle may be provided for increased handler comfort, particularly during extended walks or when managing a strong, pulling dog. Alternatively, a plastic bicycle-style handle may be incorporated to provide ergonomic grip and reduced hand strain. Regardless of the handle style employed, the critical feature of removable hardware at the attachment end remains consistent across all embodiments.

### Method of Use

To use the invention, a pet owner simply attaches the leash to their dog's collar or harness using carabiner 24 in the conventional manner. After use, when the leash requires cleaning, the user opens latch 25 of carabiner 24 and removes it from carabiner loop 22. Any additional hardware such as secondary carabiners 27 or D-rings 29 may also be removed from their respective accessory loops.

The leash can then be placed directly into a washing machine along with other items or by itself. For optimal sanitization, a “sterilization” wash setting with high water temperature is recommended. However, a “normal” wash cycle will also provide excellent cleaning results. Standard laundry detergent may be used.

The leash will not need much drying time if any. Once washed, it is ready to go.

By machine washing the leash regularly as intended, the transmission of harmful pathogens, parasites, allergens, and infectious diseases can be minimized if not eradicated, promoting better health for both pets and their human companions.

### Additional Embodiments and Modifications

It should be understood that the foregoing description relates to exemplary embodiments of the invention and that modifications may be made without departing from the spirit and scope of the invention as set forth in the following claims.

For example, while the illustrated embodiments show a leash with carabiner loops at the hardware end, other removable attachment mechanisms could be employed, such as loops configured for snap hooks, trigger hooks, or bolt snaps, provided that the hardware remains removable to enable machine washing of the fabric components.

Similarly, while electrical grade PVC is the preferred material for the flexible strap, other suitable materials such as polyester, polypropylene, or blended fabrics that can withstand machine washing may be substituted as a matter of application specific design choice for the internal webbing.

The length of the leash may vary according to user preference and intended application. While a 5-foot length is described as preferred, leashes of 4 feet, 6 feet, 8 feet, or longer (or shorter) may be constructed using the same removable hardware principles.

Additional features such as traffic handles (short loops near the hardware end for close control), bungee sections for shock absorption, or dual-attachment points for walking multiple dogs may be incorporated into the design while maintaining the core functionality of removable hardware for machine washing.

It should be understood, of course, that the foregoing relates to exemplary embodiments of the invention and that modifications may be made without departing from the spirit and scope of the invention as set forth in the following claims.

What is claimed is:

1. A washable pet leash comprising:
a flexible strap having a first end and a second end;
a handle portion disposed at said first end of said flexible strap;
at least one carabiner loop disposed at said second end of said flexible strap, wherein said carabiner loop is configured to removably receive an interchangeable and detachable hardware device; and
wherein said hardware device is removable from said carabiner loop to allow said flexible strap to be machine washed without said hardware device.

2. The washable pet leash of claim 1, wherein said flexible strap comprises an electrical grade PVC material.

3. The washable pet leash of claim 1, wherein said flexible strap has a length of approximately five feet.

4. The washable pet leash of claim 1, wherein said hardware device is a carabiner.

5. The washable pet leash of claim 1, further comprising at least one accessory loop positioned adjacent to said handle portion, wherein said accessory loop is configured to receive removable hardware.

6. The washable pet leash of claim 5, wherein said accessory loop is secured with safety stitching.

7. The washable pet leash of claim 1, further comprising at least one accessory loop positioned adjacent to said carabiner loop, wherein said accessory loop is configured to receive removable hardware.

8. The washable pet leash of claim 7, wherein said accessory loop is secured with safety stitching.

9. The washable pet leash of claim 7, further comprising a second carabiner removably coupled to said accessory loop.

10. The washable pet leash of claim 7, further comprising a D-ring removably coupled to said accessory loop.

11. The washable pet leash of claim 1, wherein said carabiner loop is secured with safety stitching.

12. The washable pet leash of claim 1, wherein said carabiner loop is configured to allow said flexible strap to be threaded through said carabiner loop to shorten said leash.

13. The washable pet leash of claim 1, wherein said handle portion comprises a padded handle.
